(19) United States
(12) Patent Application Publication
(10) Pub. No.: US 2002/0193151 A1
(43) Pub. Date: Dec. 19, 2002

(54) Cell phone retractable earpiece

(76) Inventor: David B. Edreich, Sarasota, FL (US)

Correspondence Address: Edward M. Livingston, Esq., 628 Ellen Dr., P.O. Box 1599, Winter Park, FL, 32790, US

(21) Appl. No.: 09/835,906

(22) Filed: Apr. 16, 2001

(51) Int. Cl. H04B 1/38

(52) U.S. Cl. 455/569; 455/90; 455/550; 455/66; 455/74

(57) ABSTRACT

A cell-phone retractable earpiece has a phone-wire reel (1) in a reel pocket (2) on a cell phone (3) that is attachable to a user. The phone-wire reel is wind-tensioned to wind the phone wire onto the phone-wire reel in opposition to pulling the phone wire and locking the reel in a desired unwound mode. The earpiece is attached to a user's ear (9) with an ear hook (7) having a sound reproducer (14) with a sound conveyor (15, 19, 20) into a user's ear (9). A microphone retractable appendage (26) is extendible from the phone wire to a position proximate a user's mouth (18). An optional ear clamp (21) can be employed for firm attachment of the earpiece to the user's ear.

### BACKGROUND OF THE INVENTION

This invention relates to earpieces for cellular phones and more particularly to a cell-phone retractable earpiece on a phone wire that is spring-wound into and out from a line pocket that is built into or attachable to a cellular phone

Holding cell phones while using them has become a well-known hazzard. A wide selection of hands-free cell-phone systems have been devised as remedies but not with the convenience, effectiveness and reliability of a spring-coiled phone wire to an ear-hooked earpiece in a manner taught by this invention.

Examples of most-closely related known but different devices are described in the following patent documents:

| | | |
|---|---|---|
| | | Issue |
| Patent No. | Inventor | Date |

| | | |
|---|---|---|
| 5,613,222 | Guenther | Mar. 18, 1997 |
| 5,422,957 | Cummins | June 06, 1995 |
| 4,942,617 | Boylan | July 17, 1990 |
| 4,864,610 | Stevens | Sept. 05, 1989 |
| 4,754,484 | Larkin, et al. | June 28, 1988 |
| 4,420,657 | Larkin | Dec. 13, 1983 |

Referring to the above patent documents, Guenther described a different type of head set in communication with a cellular phone with a flexible acoustical tube instead of with a spring-coiled wire as taught by this invention. Cummins described a cable take-up for connecting headphones to an entertainment device having a hollow case, a spindle for a flat cable, an electrical plug and other limiting features different from a smaller and more compact retractable earpiece taught by Applicant. Boylan described an earphone cord take-up device with a hollow casing worn on a belt instead of being built into or attachable to a cellular phone on an end of a phone wire that is retractable into a cell-phone pocket on a cellular phone. Stevens described a conical ear cushion on a tip of a flexible sound tube in communication with a user's inner ear. Larkin, et al. taught a miniature handset that is convertible into a headset for use in conjunction with a telephone base set. Larkin described an adjustable headset having a microphone on a boom in addition to the cylindrical cushion described by Larkin, et al.

### SUMMARY OF THE INVENTION

Objects of patentable novelty and utility taught by this invention are to provide a cell-phone retractable earpiece which:

attaches an earpiece stably, effectively, comfortably and conveniently to a user's ear for hands-free use of a cell phone that is positioned wherever desired on the user;

has an automatically retractable phone line from the cell phone to the ear piece;

avoids entanglement of cell-phone line;

takes minimal space on a cell phone; and

can be built onto or attached to a cell phone.

This invention accomplishes these and other objectives with a cell-phone retractable earpiece having a phone-wire reel in a reel pocket on a cell phone that is attachable to a user. The phone-wire reel is wind-tensioned to wind the phone wire onto the phone-wire reel in opposition to pulling the phone wire and locking the reel in a desired unwound mode. The earpiece is attached to a user's ear with an ear hook having a sound reproducer with a sound conveyor into a user's ear. A retractable microphone is extendible from the phone wire to a position proximate a user's mouth. An optional ear clamp can be employed for firm attachment of the earpiece to the user's ear.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a partially cutaway side view of the cell-phone retractable earpiece on a dashed-line representation of a cell-phone user's ear;

FIG. 2 is a side view of a reel pocket on a cell phone;

FIG. 3 is a front view of the FIG. 1 illustration;

FIG. 4 is an exploded front view of a sound reproducer with a miniature conical horn as a sound magnifier on and adjustable-size ear hook;

FIG. 5 is the FIG. 4 illustration with tubular communication to an inside portion of an ear;

FIG. 6 is a head-top view showing an optional ear clamp;

FIG. 7 is a side view of an ear portion of the FIG. 6 illustration; and

FIG. 8 is a partially cutaway and exploded side view of a phone-wire reel having a mechanical spring motor for winding tension.

### DESCRIPTION OF PREFERRED EMBODIMENT

Listed numerically below with reference to the drawings are terms used to describe features of this invention. These terms and numbers assigned to them designate the same features throughout this description.

| | | | |
|---|---|---|---|
| 1. | Phone-wire reel | 16. | Microphone |
| 2. | Reel pocket | 17. | Microphone extension |
| 3. | Cell phone | 18. | User's mouth |
| 4. | Head | 19. | Conical horn |
| 5. | Phone wire | 20. | Tubular member |
| 6. | Reel axle | 21. | Ear clamp |
| 7. | Ear hook | 22. | First clamp jaw |
| 8. | Ear rest | 23. | Second clamp jaw |
| 9. | User's ear | 24. | Ear-grasp member |
| 10. | Ear-aft curvature | 25. | Clamp connector |
| 11. | Hook bottom | 26. | Retractable appendage |
| 12. | Ear-size adjuster | 27. | Electrical motor |
| 13. | Ear cavity | 28. | Mechanical spring |
| 14. | Sound reproducer | 29. | Phone-wire clamp |
| 15. | Sound conveyor | 30. | Un-locker |

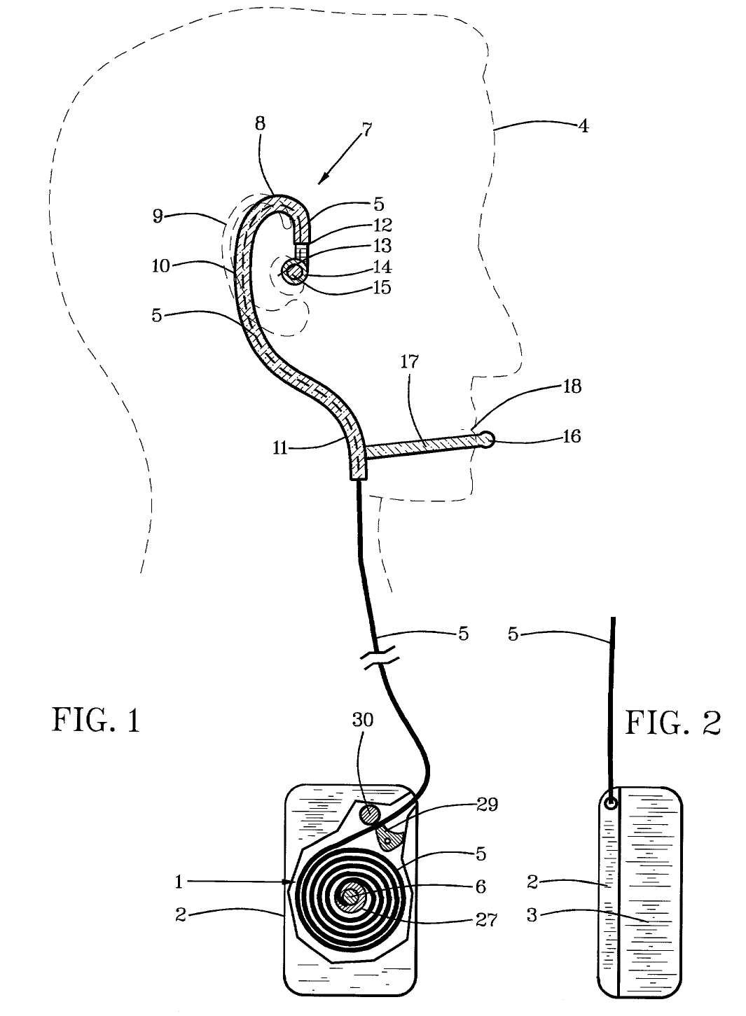

Referring first to FIGS. 1-3, a phone-wire reel 1 is wind-tensioned in a reel pocket 2 on a cell phone 3 that is attachable to a cell-phone user represented by a dashed-line head 4 of the cell-phone user. Phone wire 5 is in phone-electrical sound communication with the cell phone 3 proximate a reel end of the phone wire 5 that is attached to a reel axle 6 onto which the phone wire 5 is windable. The reel axle 6 is wind-tensioned to wind the phone wire 5 onto the phone-wire reel 1 in predetermined opposition to pulling the phone wire 5 and locking the reel axle 6 in a selectively unwound mode.

An ear hook 7 containing an ear-hook portion of the phone wire 5 has an ear rest 8 on a top of a user's ear 9, an ear-aft curvature 10 and a hook bottom 11 proximate a bottom of the user's ear 9. An ear-size adjuster 12 containing an adjuster portion of the phone wire 5 has adjustability of length of the ear-size adjuster 12 intermediate the top of the user's ear 9 and an ear cavity 13 of the user's ear 9.

A sound reproducer 14 on a bottom of the ear-size adjuster 12 proximate the ear cavity 13 has a sound conveyor 15 in sound communication intermediate the sound reproducer 14 and a predetermined position in the ear cavity 13.

A microphone 16 on a microphone extension 17 is in phone-sound communication with the phone wire 5 proximate a user's mouth 18.

Referring to FIGS. 1 and 3-5, the sound reproducer 14 can include a conical horn 19 as shown in FIG. 4 or a tubular member 20 as shown in FIG. 5 to convey sound from the sound reproducer 14 towards an inner portion of the user's ear 9. The conical horn 19 can circle an entrance and the tubular member 20 can enter the inner portion of the user's ear 9.

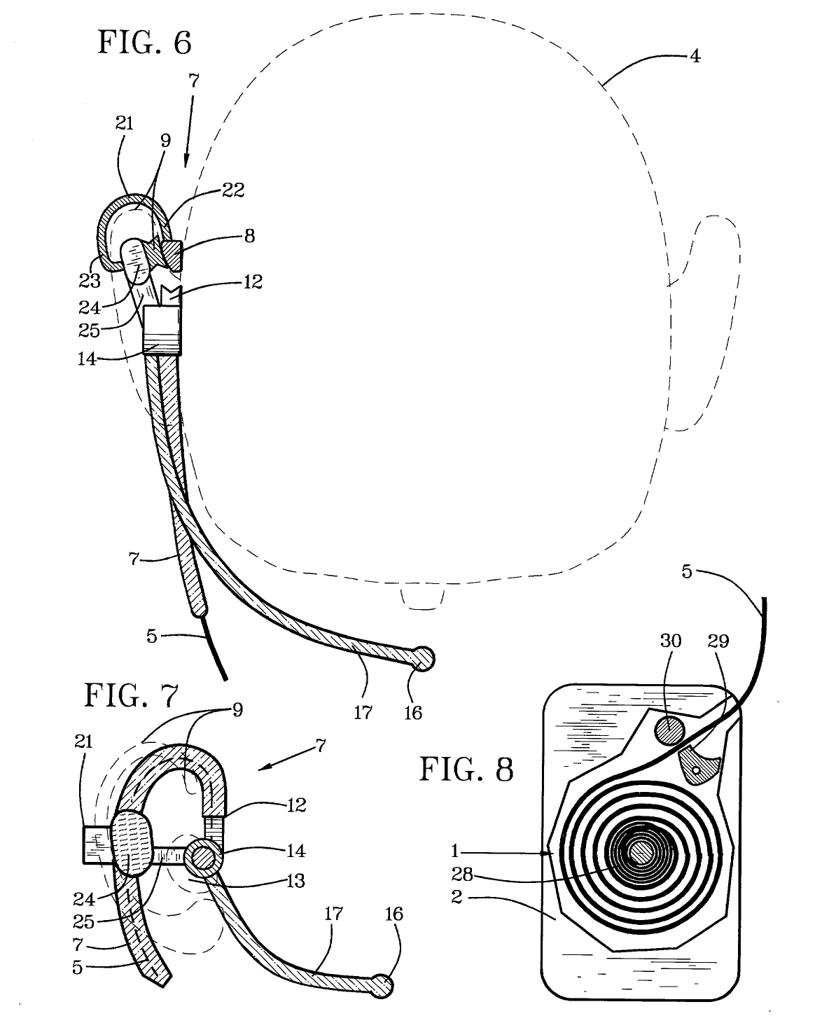

Referring to FIGS. 6-7, the ear hook 7 can include an ear clamp 21 having a first clamp jaw 22 attached to the ear hook 7 and a second clamp jaw 23 with an ear-grasp member 24 attached to the sound reproducer 14. The ear clamp 21 can be a resilient member that is positioned over a top of the user's ear 9 as shown in FIG. 6 or at desired positions intermediate a back of the user's ear 9 as shown in FIG. 7 and the top of the user's ear 9. Preferably, the ear-grasp member 24 is broadly cushioned and the ear hook 7 also is broadly cushioned for long-lasting comfort of grasping of the user's ear 9 as shown cross hatched in FIG. 6 between the ear rest 8 and the ear-grasp member 24. Positioning of the ear clamp 21 approximately in line horizontally with the sound reproducer 14 and the ear cavity 13 as shown in FIG. 7 is preferable to ear-top positioning shown in FIG. 6 because the ear cavity 13 is close to the back of the user's ear 9, a clamp connector 25 can be shorter and ear-grasping is most effective.

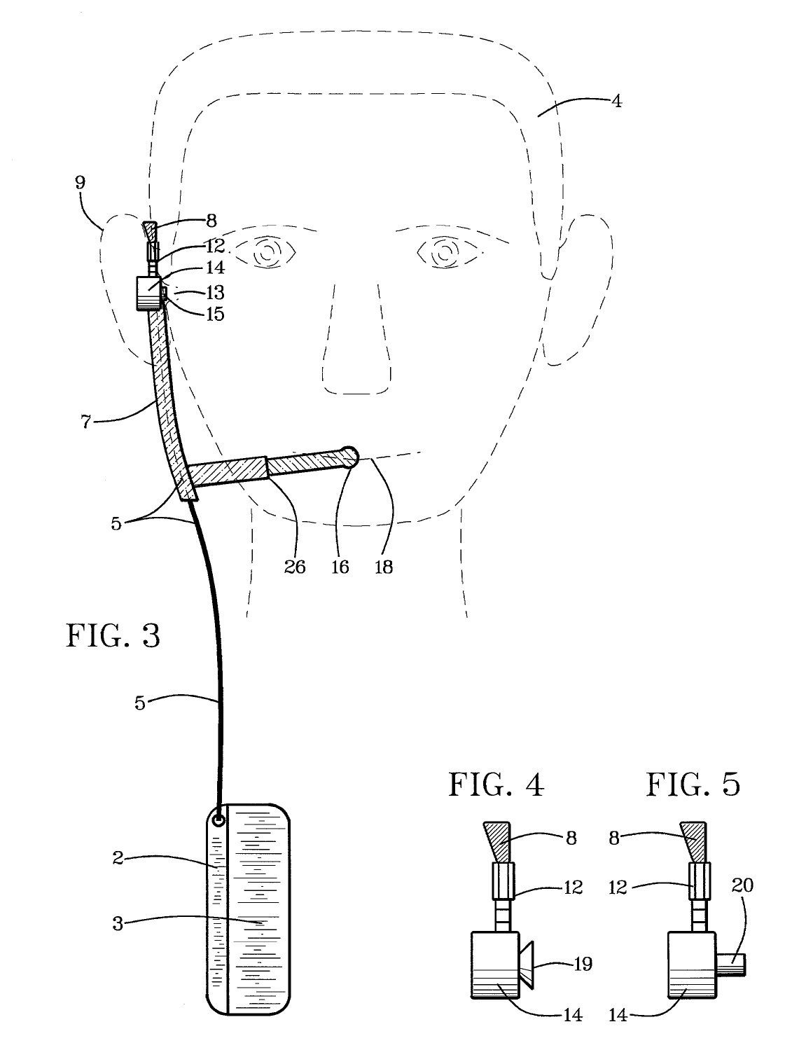

Referring to FIGS. 1, 3 and 6-7, the microphone extension 17 can be extended firmly from proximate the sound reproducer 14 as shown in FIGS. 6-7 when the ear clamp 21 is used, but can be extended from any desired position along the ear hook 7 or the phone wire 5. Optionally, the microphone 16 can be positioned on a retractable appendage 26 that can be extended from the ear hook 7 as shown in FIG. 3 or from the phone wire 5.

The reel axle 6 can be wind-tensioned with an electrical motor 27 as shown in FIG. 1 or with a mechanical spring 28 that is represented by a clock spring illustrated in FIG. 8.

As shown in FIGS. 1 and 8, the phone-wire reel 1 is locked in the selectively unwound mode with a winding lock that can be a phone-wire clamp 29 that can include an un-locker 30 having unlock communication to the winding lock. The unlock communication can include a double jerk of the phone wire 5 or a predetermined touching of the reel pocket 2 for activating travel of the un-locker 30 in a direction of separation from the phone-wire clamp 29.

The phone wire 5 has a length of preferably about three feet and can be standard phone wire that is used commonly intermediate a phone jack and a telephone handset. Optionally, the phone wire 5 can be customized phone wire having an insulated outside perimeter that is circumferential with a diameter of approximately two millimeters and contains all standard phone-wire lines with predeterminedly thin insulation. The reel pocket 2 has a thickness of preferably about one-quarter inch, a width not greater than a width of the cell phone 3 and a length not greater than a length of the cell phone 3.

A new and useful cell-phone retractable earpiece having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A cell-phone retractable earpiece comprising:
a phone-wire reel in a reel pocket on a cell phone that is attachable to a cell-phone user;
phone wire in phone-electrical communication with the cell phone proximate a reel end of the phone wire that is attached to a reel axle onto which the phone wire is windable;
the reel axle being wind-tensioned to wind the phone wire onto the phone-wire reel in opposition to pulling the phone wire and locking the reel axle in a selectively unwound mode;
an ear hook containing an ear-hook portion of the phone wire;
the ear hook having an ear rest on a top of a user ear, an ear-aft curvature and a hook bottom proximate a bottom of the user ear;
an ear-size adjuster containing an adjuster portion of the phone wire and having adjustability of length of the ear-size adjuster intermediate the top of the ear and an ear cavity of the user's ear;
a sound reproducer on a bottom of the ear-size adjuster proximate the ear cavity;
a sound conveyor in sound communication intermediate the sound reproducer and a predetermined position in the ear cavity; and
a microphone on a microphone extension in phone-sound communication with the phone wire proximate a user's mouth.

2. The cell-phone retractable earpiece of claim 1 wherein:
the sound reproducer includes a miniature conical horn that circles an entrance to an inner portion of the user ear.

3. The cell-phone retractable earpiece of claim 1 wherein:
the sound reproducer includes a tubular member that is extended predeterminedly towards an inner portion of the user ear.

4. The cell-phone retractable earpiece of claim 1 wherein:
the ear hook includes an ear clamp having a first clamp jaw attached to the ear hook and a second clamp jaw with an ear-grasp member attached to the sound reproducer.

5. The cell-phone retractable earpiece of claim 4 wherein:
the microphone is extended from the phone wire proximate the sound reproducer to proximate the mouth of the cell-phone user.

6. The cell-phone retractable earpiece of claim 4 wherein:
the microphone is extended from the phone wire at proximate a bottom of the ear hook to proximate the mouth of the cell-phone user.

7. The cell-phone retractable earpiece of claim 1 wherein:
the microphone is extended from the phone wire proximate the sound reproducer to proximate the mouth of the cell-phone user.

8. The cell-phone retractable earpiece of claim 1 wherein:
the microphone is on a retractable appendage for selectively retractable positioning of the microphone intermediate the phone wire and the user's mouth.

9. The cell-phone retractable earpiece of claim 4 wherein:
the microphone is on a retractable appendage for selectively retractable positioning of the microphone intermediate the phone wire and the user's mouth.

10. The cell-phone retractable earpiece of claim 1 wherein:
the reel axle is wind-tensioned with an electrical motor.

11. The cell-phone retractable earpiece of claim 1 wherein:
the reel axle is wind tensioned with a mechanical spring.

12. The cell-phone retractable earpiece of claim 1 wherein: the phone-wire reel is locked in the selectively unwound mode with a winding lock.

13. The cell-phone retractable earpiece of claim 12 wherein:
the winding lock includes a phone-wire clamp.

14. The cell-phone retractable earpiece of claim 12 wherein:
the winding lock includes an un-locker that unlocks the winding lock with an unlock communication to the winding lock.

15. The cell-phone retractable earpiece of claim 14 wherein:
the unlock communication includes a double jerk of the phone wire.

16. The cell-phone retractable earpiece of claim 14 wherein:
the unlock communication includes a predetermined touching of the reel pocket.

17. The cell-phone retractable earpiece of claim 1 wherein:
the phone wire has a length of approximately three feet.

18. The cell-phone retractable earpiece of claim 1 wherein:
the phone wire is standard phone wire that is used commonly intermediate a phone jack and a telephone handset.

19. The cell-phone retractable earpiece of claim 1 wherein:
the phone wire is customized phone wire having an insulated outside perimeter that is circumferential with a diameter of approximately two millimeters and contains all standard phone-wire lines with predeterminedly thin insulation on the phone-wire lines.

20. The cell-phone retractable earpiece of claim 1 wherein:
the reel pocket has a thickness of approximately one-quarter inch, a width no greater than a width of the cell phone and a length no greater than a length of the cell phone.
